(19) United States
(12) Patent Application Publication
(10) Pub. No.: US 2013/0213241 A1
(43) Pub. Date: Aug. 22, 2013

(54) METHOD AND DEVICE FOR WASHING RICE

(71) Applicants: Eng Cheng Khaw, Eindhoven (NL); Jingwei Tan, Eindhoven (NL)

(72) Inventors: Eng Cheng Khaw, Eindhoven (NL); Jingwei Tan, Eindhoven (NL)

(73) Assignee: KONINKLIJKE PHILIPS ELECTRONICS N.V., EINDHOVEN (NL)

(21) Appl. No.: 13/881,478

(22) PCT Filed: Oct. 17, 2011
(86) PCT No.: PCT/IB2011/054593

§ 371 Date: Apr. 25, 2013

(30) Foreign Application Priority Data
Oct. 28, 2010 (CN) PCT/CN2010/078193

(51) Int. Cl. A47J 43/24

(52) U.S. Cl. CPC A47J 43/24
USPC 99/334; 134/18; 134/56 R

(57) ABSTRACT

The invention proposes a method and a device for washing rice according to the target taste of rice after the rice has been cooked. The device (1) comprises a first unit (11) for obtaining first data related to features of the rice, a second unit (12) for obtaining second data related to the target taste of cooked rice, a third unit (13) for determining a washing scheme according to the features of the rice and the target taste, and a fourth unit (14) for washing the rice according to the determined washing scheme. In embodiments of the invention, the washing of rice is dependent on the target taste of the cooked rice, thus flexibility is enabled. The user just selects his target taste and the rice will be washed accordingly so as to help achieve this target taste after the rice has been cooked.

### TECHNICAL FIELD

The present invention relates to kitchenware, and particularly to washing rice.

### BACKGROUND

Rice is a common staple food in East Asia. Before being cooked, rice is usually washed to remove dirt. Some of the commercially available automatic rice cookers have a washing function. For example in U.S. Pat. No. 5,595,105, an automatic rice cooking apparatus is proposed, and the apparatus includes a rice washing section, which is supplied with a predetermined amount of rice from a rice box via a measuring cup and which is adapted to wash the rice with water supplied at a uniform water pressure. The prior art mainly focuses on automation of washing without user intervention, as reflected in the mechanical design for the rice-washing apparatus.

### SUMMARY OF THE INVENTION

For various reasons, the washing of rice greatly influences the taste of rice after it has been cooked. One of the reasons relates to the starch contained in rice. The rice grain has tiny apertures on its surface, and if the starch is not washed off sufficiently, the starch will fill these apertures, thereby preventing the water used for cooking rice from penetrating into the rice, as a result of which the rice is cooked unevenly: the surface of the rice after being cooked is tender but the rice is tough on the inside; on the contrary, if the starch is removed sufficiently, the rice will be cooked more evenly, resulting in a better taste. In addition, the removal of the starch will also influence the stickiness, the sweetness, and the toughness of the rice after being cooked. Therefore, it is confusing to consumers that they do not know how to properly wash rice. Some consumers even complain that “Washing rice is one of my least favourite chores . . . ” In reality, there are many types of rice and this will make the confusion worse.

As can be seen in the prior art, the rice is washed without considering the taste requirement for the cooked rice. Thus, it would be advantageous to wash the rice flexibly in order to obtain the preferred taste of the cooked rice.

To this end, in a first aspect of the invention, there is provided a method of washing rice, comprising: obtaining first data related to features of the rice and second data related to the target taste of the cooked rice; determining the washing scheme according to the features of the rice and the target taste; and washing the rice according to the determined washing scheme.

In this aspect, the washing of rice depends on the target taste of cooked rice, thus, flexibility is obtained. The user just selects his target taste and the rice will be washed accordingly to provide this taste.

In a preferred embodiment of the first aspect, the features of the rice correspond to at least one of: type of rice; quantity of the rice; quality of the rice; and degree of greenness of the rice. The target taste corresponds to at least one of: hardness; sweetness; stickiness; resilience. And the washing scheme comprises at least one of: number of times that washing is performed; the method of washing for each one of the number of washing steps; the amount of water to be used for each one of the number of washing steps; and the duration of each one of the number of washing steps.

In this preferred embodiment, the washing operation depends on various features of the rice, various tastes of the cooked rice, and the rice can be washed by using various washing schemes. The flexibility is further increased.

In another preferred embodiment of the first aspect, the washing step is executed at least once, the washing scheme comprises third data corresponding to the designated amount of starch to be washed off the rice; the method further comprises the steps of:
monitoring the overall actual amount of starch washed off the rice after each of the washing steps;
   wherein, if the overall actual amount of starch washed off the rice equals or exceeds the designated amount of starch to be washed off the rice,
washing is stopped;

### Otherwise:

the next washing step is started according to the washing scheme, or
the washing scheme is adjusted for the next washing step, according to the difference between the overall actual amount of starch being washed off the rice and the designed amount of starch to be washed off the rice, and the next washing step is started according to the adjusted washing scheme.

In this preferred embodiment, the target taste is related to a designated amount of starch to be washed off the rice. And the actual amount of starch washed off is monitored for each one of the number of washing steps so as to ensure the accordance between the designated and the actual amounts. Thus, the monitoring is in real time and washing is more accurate. Besides, this embodiment adjusts the washing scheme for the next washing step according to the difference between the designated and the actual amounts; for example, more water and a longer washing period are proper for the next washing step if the difference is large, and less water and a shorter washing period are proper if the difference is small. As a result, the washing process is more accurate and flexibility is further increased.

In one preferred embodiment, said monitoring step comprises: detecting the amount of starch washed off the rice in the latest washing step; determining the overall actual amount of starch washed off the rice by calculating the sum of the amounts of starch washed off the rice in all of the previous washing steps. Advantageously, the step of detecting the amount of starch washed off the rice in the latest washing step comprises the following sub-steps: detecting at least one of the electric conductivity and the turbidity of the water in the latest washing step, and measuring the volume or weight of the water; and calculating the amount of starch being washed off the rice in the latest washing step according to the measured volume or weight of the water and at least one of the detected electric conductivity and the turbidity.

In another preferred embodiment, said monitoring step comprises: measuring the weight of the rice before being washed; measuring the weight of the rice after the latest washing step; and determining the overall actual amount of starch washed off the rice by calculating the weight difference between the weight of the rice before being washed and the weight of the rice after the latest washing step.

The above preferred embodiments provide different solutions to monitor the actual amount of starch washed off the rice.

In still another preferred embodiment, the step of determining the washing scheme comprises at least one of: storing the washing scheme that was used when the overall actual amount of starch washed off the rice equaled or exceeded the designated amount of starch to be washed off the rice; and retrieving the stored washing scheme.

In this embodiment, in the case that the overall actual amount of starch conforms to the designated amount and washing has finished, the washing scheme used at this point in time can be saved and used for future rice washing. Therefore, there is no need to monitor the overall actual amount of starch in real time in future rice washing operations, and an alternative solution for washing rice is provided.

In a second aspect of the invention, there is provided a device for washing rice, comprising: a first unit for obtaining first data related to features of the rice; a second unit for obtaining second data related to the target taste of cooked rice; a third unit for determining the washing scheme according to the features of the rice and the target taste; and a fourth unit for washing the rice according to the determined washing scheme.

In a third aspect of the invention, there is provided a rice cooker comprising a device according to the second aspect of the invention.

These and other features of the present invention will be described in detail in the embodiment part.

### BRIEF DESCRIPTION OF THE DRAWINGS

Features, aspects and advantages of the present invention will become obvious by reading the following description of non-limiting embodiments with reference to the appended drawings. In the drawings, same or similar reference numerals refer to the same or similar steps or means.

FIG. 1 shows a schematic view of the device for washing rice according to one embodiment of the invention;

FIG. 2 shows a flowchart of the method of washing rice according to one embodiment of the invention.

### DETAILED DESCRIPTION OF EMBODIMENTS

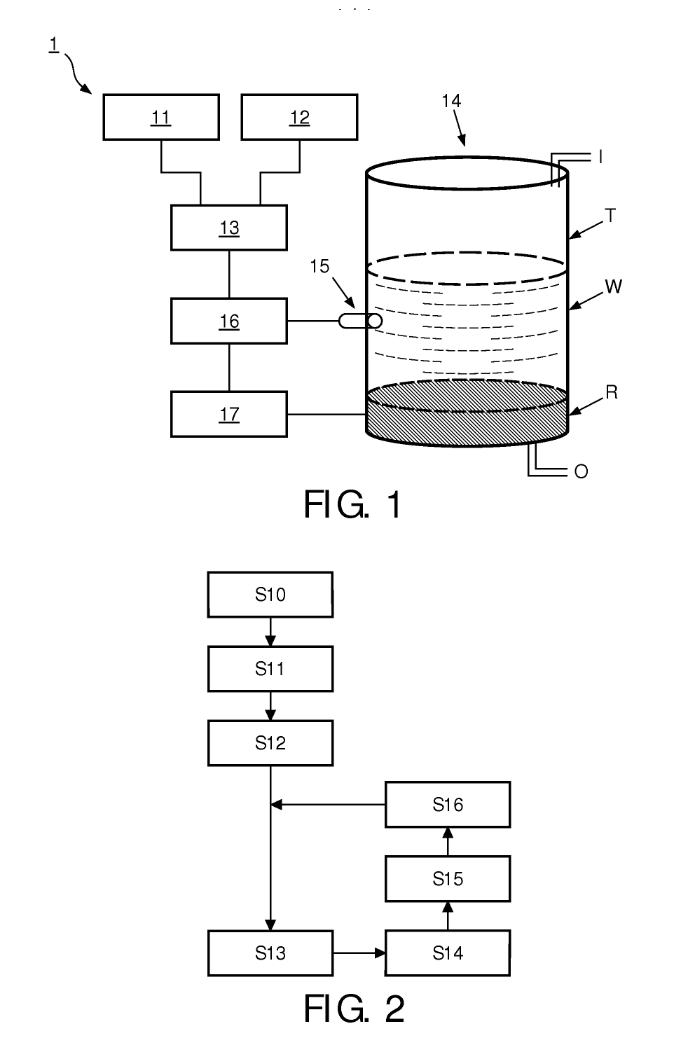

With reference to FIG. 1 and FIG. 2, the concept of the invention will be elucidated by describing the device and the method according to embodiments of the invention.

As shown in FIG. 1, the device 1 for washing rice comprises a first unit 11 for obtaining first data related to features of the rice, a second unit 12 for obtaining second data related to the target taste of cooked rice, a third unit 13 for determining the washing scheme according to the features of the rice and the target taste, a fourth unit 14 for washing the rice according to the determined washing scheme. The device 1 can also comprise a controller, for example a micro-controlling unit (MCU) for controlling the operations of these units.

In a practical implementation, as shown in FIG. 1, the fourth unit 14 comprises a tank T for containing the rice R (shown by the shaded part) and water W (shown by the dashed lines) for washing the rice R, a water inlet I for pouring water into the tank, a water outlet O for draining water from the tank, and a unit (not shown) for washing the rice in the water, for example an ultrasonic vibrator mounted at the bottom of the tank which generates vibration to wash the rice. The water inlet I can be connected to the water tap in the kitchen and the water outlet O can be connected to the scupper in the kitchen. The device 1 can also be integrated in a rice cooker, and in order to save cost and decrease volume of the cooker, the tank may also be used as the container in which the rice is cooked. The rice cooker comprises other components for cooking rice such as heaters.

The method of washing rice comprises the steps of: obtaining first data related to features of the rice and second data related to the target taste of cooked rice; determining the washing scheme according to the features of the rice and the target taste; and washing the rice according to the determined washing scheme.

As shown in FIG. 2, in step S10, the first unit 11 obtains first data related to features of the rice. In a preferred embodiment, the features of the rice correspond to at least one of:
type of rice;
quantity of the rice;
quality of the rice;
degree of greenness of the rice.

The first unit 11 may receive the first data input from the user, or the first unit 11 may comprise sensors to detect the features of the rice. For example, a pressure sensor mounted below the tank can be used for detecting the quantity of the rice after the rice has been introduced into the tank. It should be noted that the features of rice are not limited by the above examples, and those skilled in the art could implement the corresponding first unit 10 to obtain other features of rice. The specification will not give unnecessary details.

In step S11, the second unit 12 obtains second data related to the target taste of cooked rice. In a preferred embodiment, the target taste corresponds to at least one of the following features:
hardness;
sweetness;
stickiness;
resilience.

The second unit 11 may receive the second data input from the user. In one embodiment, the user may input the target tastes one by one, for example the user inputs soft for the hardness, medium for the sweetness, sticky for the stickiness and non-resilient for the resilience. In another embodiment, the user may just select in a menu one target rice type from various types, for example ordinary rice, porridge, rice for preparing fried rice. And the second unit 11 relates to the selected rice type with the target tastes. For example, as to the rice for making fried rice, the hardness is hard, the sweetness is non-sweet, the stickiness is non-sticky and the resilience is medium. The relation between the rice types and the target tastes can be pre-stored in a memory in the second unit 11, or downloaded from the Internet. It should be noted that the target taste is not limited by the above examples.

In step S12, the third unit 13 determines the washing scheme according to the features of the rice and the target taste.

### Embodiment One

In this embodiment, the washing scheme comprises at least one of:
number of times washing is performed;
the method of washing for each one of the number of washing steps;
the amount of water to be used for each one of the number of washing steps;
the duration of each one of the number of washing steps.

The relation between the washing scheme on the one hand, and the features of rice and the target taste on the other hand can be pre-stored in a memory in the third unit 13 or can be downloaded from the Internet or any other suitable data source by the third unit 13. The relations in the following table 1 are examples.

TABLE 1

| | | Taste | | Washing scheme | |
|---|---|---|---|---|---|
| Rice type | Quantity | Hardness | Sweetness | Time | Duration |
| North east rice | 2 cups | Hard | medium | 1 | 2 min |
| (long grain) | | Soft | sweet | 2 | 4 min |
| | 3 cups | Hard | medium | 1 | 3 min |
| | | Soft | sweet | 3 | 4 min |
| Tai rice | 2 cups | medium | sweet | 1 | 2 min |
| (short grain) | | | | | |
| Brown rice | 2 cups | medium | sweet | 2 | 2 min |

Let's take 2 cups of north east rice as an example. The target taste required by the user is soft and sweet. Thus, the corresponding washing scheme is washing the rice twice for 4 minutes each time. These washing schemes can originate from experiments carried out by the manufacturer or vendor. It should be noted that the washing scheme is not limited by the above examples.

In step S13, the fourth unit 14 washes the rice according to the determined washing scheme. Again, 2 cups of north east rice is taken as an example. The target taste required by the user is soft and sweet. The fourth unit 14 first pours clean water into the tank, and washes the rice for 4 minutes. After that, the fourth unit drains the waste water, pours clean water into the tank again and washes the rice for another 4 minutes. After that, the washing operation is complete.

### Embodiment Two

In another embodiment, the target taste is related to the designated amount of starch washed off the rice, and the actual amount of starch washed off is monitored and compared with the designated amount. In this embodiment, as shown in FIG. 1, the device 1 further comprises a fifth unit 15 for monitoring the overall actual amount of starch washed off the rice after each wash, and a sixth unit 16 for comparing the overall actual amount of starch washed off the rice with the designated amount of starch to be washed off the rice.

In this embodiment, in step S12, the third unit 13 determines third data corresponding to the designated amount of starch to be washed off the rice. The relation between the designated amount of starch to be washed off the rice on the one hand, and the features of the rice and the target taste on the other hand can be pre-stored in a memory in the third unit 13 or can be downloaded from the Internet or any other suitable data source. The following table 2 is an example.

TABLE 2
Washing parameters

| | | Taste | | Amount of starch |
|---|---|---|---|---|
| Rice type | Quantity | Hardness | Sweetness | to be washed off |
| North east rice | 2 cups | Hard | medium | 10 grams |
| (long grain) | | Soft | sweet | 20 grams |
| | 3 cups | Hard | medium | 15 grams |
| | | Soft | sweet | 30 grams |
| Tai rice | 2 cups | medium | sweet | 15 grams |
| (short grain) | | | | |
| Brown rice | 2 cups | medium | sweet | 20 grams |

Besides, in step S12, the third unit 13 also determines the washing scheme for washing rice, for example a certain amount of water and a certain period of time. This washing scheme can be related to the quantity of the rice and can be pre-stored in the third unit 13.

As shown in FIG. 2, in step S13, the fourth unit 14 starts the first washing step according to the determined washing scheme.

After the first washing step, in step S14, the fifth unit 15 monitors the overall actual amount of starch washed off the rice after this washing step.

In one embodiment, the fifth unit 15 comprises a detector and a first calculator. The detector detects the amount of starch washed off the rice in the latest washing step, and the first calculator 13 determines the overall actual amount of starch washed off the rice by calculating the sum of the amounts of starch washed off the rice in all of the previous washing steps.

In practice, the detector comprises a seventh unit, an eighth unit and a second calculator. The seventh unit detects at least one of the electric conductivity and the turbidity of the water in the latest washing step. The eighth unit obtains the volume or weight of the water. The second calculator calculates the amount of starch washed off the rice in the latest washing step according to the measured volume or weight of the water and at least one of the electric conductivity and the turbidity. In an implementation, the seventh unit can be an electrical or optical sensor to measure the starch concentration in the water, and the eighth unit can be a pressure sensor. The second calculator can be implemented by the MCU, and it calculates the amount of starch contained in the water by multiplying the starch concentration and the volume or weight of the water. Those skilled in the art could implement the units for measuring the starch concentration according to the electric conductivity and turbidity of the water, therefore, the specification will not give unnecessary details.

In another embodiment, the fifth unit 15 comprises a ninth unit, a tenth unit and a third calculator. The ninth unit measures the weight of the rice prior to being washed. The tenth unit measures the weight of the rice after the latest washing step. And the third calculator determines the overall actual amount of starch washed off the rice by calculating the weight difference between the weight of the rice prior to being washed and the weight of the rice after the latest washing step. In an implementation, the ninth and tenth units can be a single pressure sensor or two different pressure sensors. And the third calculator can be implemented by the MCU.

This example is based on 2 cups of north east rice. The target taste is soft and sweet. After the first washing step, the fifth unit 15 determines that the overall actual amount of starch washed off is 12 grams. It can be seen from table 2 that the designated amount is 20 grams. In step S15, the sixth unit 16 compares the overall actual amount of 12 grams of starch washed off the rice with the designated amount of 20 grams of starch to be washed off the rice.

Since the actual amount is less than the designated amount, additional washing is necessary. Preferably, the device 1 further comprises an adjusting unit 17. The adjusting unit 17 adjusts the washing scheme, determined by the third unit, for the next washing step, according to the difference between the overall actual amount and the designated amount of starch. For example, several difference thresholds are defined in the adjusting unit: if the difference is above 10 grams, the amount of washing water and the time period should be increased; if the difference is between 10 grams and 5 grams, the washing water and the time period should be kept constant; and if the difference is below 5 grams, the washing water and the time period need to be decreased. In this embodiment, after the first washing step, the difference is 8 grams, thus the adjusting unit 17 keeps the washing water and the time period for the second washing step unchanged.

After that, the fourth unit 14 starts the second washing step according to the washing scheme determined by the third unit 13. After the second washing step, the fifth unit 15 monitors the overall actual amount of starch again and the sixth unit 16 compares the new monitored overall actual amount with the designated amount of 20 grams. In one example, the overall actual amount of starch washed off after the second washing step is 18 grams. Thus, the adjusting unit 17 decreases the amount of water and the time period for the third washing step.

After that, the fourth unit 14 starts the third washing step by using the decreased amount of water for the decreased period of time. After the third washing step, the fifth unit 15 monitors the overall actual amount of starch again. In one example, the overall actual amount of starch washed off after the third washing step is 20 grams. The sixth unit 16 compares the new monitored overall actual amount with the designated amount of 20 grams. Since the overall actual amount equals the designated amount, the fourth unit 15 stops the washing cycle, which is now completed.

The above units, for example the first unit, the second unit and the third unit can be implemented by way of either software, hardware or a combination thereof. For example, the program codes for achieving the functions of these units are stored in a memory. These codes are loaded and executed by the MCU, which controls the device 1. For another example, a certain IC chip achieves the functions of these units, and the chip can be controlled by the MCU. Those skilled in the art could implement embodiments of the invention in various ways according to the concept and principle taught by the description.

Those of ordinary skill in the art could understand and realize modifications to the disclosed embodiments, through studying the description, drawings and appended claims. All such modifications which do not depart from the spirit of the invention are intended to be included within the scope of the appended claims. The word “comprising” does not exclude the presence of elements or steps not listed in a claim or in the description. The word “a” or “an” preceding an element does not exclude the presence of a plurality of such elements. In the practice of the present invention, several technical features in the claim can be embodied by one component. In the claims, any reference signs placed between parentheses shall not be construed as limiting the claims.

1. A method of washing rice, comprising the steps of:
obtaining first data related to features of the rice to be cooked;
obtaining second data related to the target taste of the cooked rice;
determining a washing scheme according to the features of the rice and the target taste;
washing the rice according to the determined washing scheme.

2. A method as claimed in claim 1, wherein the features of the rice correspond to at least one of:
type of rice;
quantity of the rice;
quality of the rice;
degree of greenness of the rice;
the target taste corresponds to at least one of:
hardness;
sweetness;
stickiness;
resilience;
and the washing scheme comprises at least one of:
number of times washing is performed;
the method of washing for each one of the number of washing steps;
the amount of water to be used for each one of the number of washing steps;
the duration of each one of the number of washing steps.

3. A method as claimed in claim 1, wherein the washing step is executed at least once, the determining step further determines third data corresponding to the designated amount of starch to be washed off the rice; the method further comprising the steps of:
monitoring the overall actual amount of starch washed off the rice after each of the washing steps;
wherein, if the overall actual amount of starch washed off the rice equals or exceeds the designated amount of starch to be washed off the rice,
washing is stopped;
Otherwise:
the next washing step is started according to the washing scheme, or
the washing scheme is adjusted for the next washing step, according to the difference between the overall actual amount of starch washed off the rice and the designated amount of starch to be washed off the rice, and starting the next washing step according to the adjusted washing scheme.

4. A method according to claim 3, wherein said monitoring step comprises:
detecting the amount of starch washed off the rice in the latest washing step;
determining the overall actual amount of starch washed off the rice by calculating the sum of the amount of starch washed off the rice in all of the previous washing steps.

5. A method according to claim 4, wherein said step of detecting the amount of starch washed off the rice in the latest washing step comprises the following sub-steps:
detecting at least one of the electric conductivity and the turbidity of the water in the latest washing step, and measuring the volume or weight of the water;
calculating the amount of starch being washed off the rice in the latest washing step according to the measured volume or weight of the water and according to the detected at least one of the electric conductivity and the turbidity of the water.

6. A method according to claim 3, wherein said monitoring step comprises:
measuring the weight of the rice before being washed;
measuring the weight of the rice after the latest washing step;
determining the overall actual amount of starch being washed off the rice by calculating the weight difference between the weight of the rice before being washed and the weight of the rice after the latest washing step.

7. A method according to claim 3, wherein the step of determining the washing scheme comprises at least one of:
storing the washing scheme that was used when the overall actual amount of starch being washed off the rice equaled or exceeded the designated amount of starch to be washed off the rice, and retrieving the stored washing scheme.

8. A device for washing rice, comprising:
a first unit for obtaining first data related to features of the rice to be cooked;
a second unit for obtaining second data, said second data being related to the target taste of the cooked rice;
a third unit for determining a washing scheme according to the features of the rice and the target taste;
a fourth unit for washing the rice according to the determined washing scheme.

9. A device as claimed in claim 8, wherein the features of the rice correspond to at least one of:
type of rice;
quantity of the rice;
quality of the rice;
degree of greenness of the rice;
the target taste corresponds to at least one of:
hardness;
sweetness;
stickiness;
resilience;
and the washing scheme comprises at least one of:
number of times washing is performed;
the method of washing for each one of the number of washing steps;
the amount of water to be used for each one of the number of washing steps;
the duration of each one of the number of washing steps.

10. A device as claimed in claim wherein the fourth unit washes the rice at least once, the third unit is further used for determining third data corresponding to the designated amount of starch to be washed off the rice, and the device further comprises:
a fifth unit for monitoring the overall actual amount of starch washed off the rice after each washing step;
a sixth unit for comparing the overall actual amount of starch washed off the rice with the designated amount of starch to be washed off the rice;
the fourth unit stops the washing step if the overall actual amount equals or exceeds the designated amount; otherwise,
the fourth unit starts the next washing step according to the washing scheme; or
the device further comprises an adjusting unit for adjusting the washing scheme for the next washing step, according to the difference between the overall actual amount of starch washed off the rice and the designated amount of starch to be washed off the rice; and the fourth unit starts the next washing step according to the adjusted washing scheme.

11. A device according to claim 10, wherein said fifth unit comprises:
a detector for detecting the amount of starch washed off the rice in the latest washing step;
a first calculator for determining the overall actual amount of starch washed off the rice by calculating the sum of the amount of starch washed off the rice in all of the previous washing steps.

12. A device according to claim 11, wherein said detector comprises:
a seventh unit for detecting at least one of the electric conductivity and the turbidity of the water in the latest washing step;
an eighth unit for measuring the volume or weight of the water;
a second calculator for calculating the amount of starch washed off the rice in the latest washing step according to the measured volume or weight of the water and according to the detected at least one of the electric conductivity and the turbidity of the water.

13. A device 44 according to claim 10, wherein said fifth unit comprises:
a ninth unit for measuring the weight of the rice before being washed;
a tenth unit for measuring the weight of the rice after the latest washing step;
a third calculator for determining the overall actual amount of starch washed off the rice by calculating the weight difference between the weight of the rice before being washed and the weight of the rice after the latest washing step.

14. A device according to claim 10, wherein the third unit comprises at least one of:
a memory for storing the washing scheme that was used when the overall actual amount of starch washed off the rice equaled or exceeded the designated amount of starch to be washed off the rice; and
a retriever for retrieving the stored washing scheme.

15. A rice cooker comprising a device for washing rice according to claim 8.
